(19) United States
(12) Patent Application Publication
(10) Pub. No.: US 2007/0158916 A1
(43) Pub. Date: Jul. 12, 2007

(54) Sealing device for cylinder bearings

(76) Inventors: Konrad Roeingh, Hilchenbach (DE); Karl Keller, Hilchenbach (DE)

Correspondence Address: FRIEDRICH KUEFFNER, 317 MADISON AVENUE, SUITE 910, NEW YORK, NY, 10017, US

(21) Appl. No.: 10/585,045

(22) PCT Filed: Dec. 9, 2004
(86) PCT No.: PCT/EP04/14030

§ 371 Date: Jun. 29, 2006

(30) Foreign Application Priority Data
Jan. 3, 2004 (DE) 2004 001 036.6
Jan. 21, 2004 (DE) 10 2004 003 699.3

(51) Int. Cl. F16J 15/32

(52) U.S. Cl. 277/551

(57) ABSTRACT

The invention relates to a sealing device for cylinder bearings, in particular, oil film bearings or roller bearings. According to the invention, a sealing ring (6) which has a cylindrically-shaped sealing surface (7) is connected to the cylinder journal (2) or the journal bushing (3). An elastic sealing element (9, 10) which is arranged in a fixed manner in a holder (8), which connected to an insertion piece (5), lies on said sealing surface. The sealing surface (7) is rolled.

### SEALING DEVICE FOR ROLL BEARINGS

The invention pertains to a sealing device for roll bearings, especially oil film bearings or roller bearings, in which a sealing ring connected to a roll neck or to a neck bush has a cylindrical sealing surface, against which an elastic sealing element rests, which is mounted nonrotatably in a holder connected to a chock.

To achieve uniform friction between a neck bush and a bearing bush, a lubricant is supplied continuously to the gap between the neck bush and the bearing bush. This is done on the assumption that the excess and/or spent lubricant will be carried away. This function is easy to ensure on the side opposite the roll, that is, at the end of the roll neck. On the side facing the roll, however, a sealing device must be provided, which prevents the uncontrolled escape of the lubricant onto the roll and onto the roll neck.

A sealing device of this type is known from EP 0 297 322 B1. According to this document, a sealing device for roll bearings in skin-pass rolling mills . . . , where the roll neck has a conical section between the end surface of the roll and the area of the roll neck on which the neck bush is mounted, this area being supported in a bearing bush in the bearing housing. The sealing device is provided with a one-piece, ring-shaped, flexible sealing body reinforced with a wire cable ring and possibly by a steel band. This ring-shaped sealing body is pushed onto the conical section and rests against it by way of ring seal shoulders. The sealing body also has two elastic, radial ring-like ribs, spaced axially apart. The outer surface of at least one of these rings rests with elastic frictional contact against at least one ring-shaped sealing surface which forms a permanent part of the housing or housing cover, to one side of the ring-shaped collar.

DE 27 31 313 C2 discloses a sealing device for roll bearings in rolling stands, in which the roll neck has a conical section between the end surface of the roll and the bearing journal, which is equipped with a neck bush and is supported in a bearing bush in the bearing housing. The sealing device has a one-piece, flexible, ring-shaped sealing body, which is pushed onto the conical section of the roll neck, against which it rests by way of ring seal shoulders.

It is known from DE 31 19 951 A1 that, in a rolling mill or rolling stand and for use in combination with a roll neck, which is surrounded by a bearing bush rotatably supported in a stationary bearing bush mounted in a bearing chock, a sealing assembly, which surrounds the conical section of the roll neck, and a circular sealing plate, which surrounds the conical part of the roll neck and is held in place relative to the bearing chock, . . . , where lubricating oil is supplied between the bearing bush and the stationary bush. The circular flexible/elastic sealing element is mounted on the conical part of the roll neck in such a way that it can rotate along with the conical part of the roll neck and has a flange, which extends outward from the sealing element and is in sealing contact with the adjacent surface of the sealing end plate. An outer sealing ring—outer with respect to the sealing end plate—is also provided and fastened in place. This outer sealing ring has a cylindrical inner surface, which cooperates with the inner surface of the sealing end plate to form a circular cavity, which is open to the end surface of the roll barrel. An inner sealing ring rests by its inner part against the flexible/elastic sealing element, whereas the outer circumferential part extends into the previously mentioned cavity, whereas the lips or shoulders, furthermore, are in sealing contact with the inner cylindrical surface of the outer sealing ring and with the end surface of the roll.

It is known that the surface of the sealing ring is produced by plunge grinding or depth grinding, after the basic shape has been produced by turning. It is also known that the surface of the sealing ring has a structure similar to a thread. Depending on the requirements and on the design of the sealing ring, this thread can be split and provided with a right-handed and a left-handed twist.

The elastic sealing elements or their sealing lips resting against the surface of the sealing ring are in direct contact with this surface, and when the rolls turn, the surface structure of the sealing ring attacks the sealing elements or lips and destroys them after a certain time.

The invention is based on the task of designing a device of the type described above in such a way that that the service life of the elastic sealing elements can be increased and friction reduced.

This task is accomplished according to the invention in that the sealing surface of the sealing ring is rolled. Advantageous embodiments of the invention are given in the subclaims.

The decisive advantage of the inventive device is that, as a result of the rolling, the sealing surface is work-hardened and its roughness is minimized. The elevations in the micrometer range which are present are made smaller and harder than those of the sealing surface present after grinding.

In an additional processing step, a plasma nitriding treatment can be applied to the sealing surface now present; that is, the surface can be subjected to a plasma diffusion process in a hot plasma jet (480-520° C.). As a result, the sealing surface is made even harder and more wear-resistant.

By subjecting the sealing surface or the part of the sealing surface which comes in contact with the elastic sealing element to an oxidation treatment as well, a smooth surface is obtained and friction is reduced at the same time. The surface processed by oxidation, furthermore, also becomes protected from corrosion.

In addition, the disadvantage of surfaces which have been coated in the conventional manner is avoided, namely, the disadvantage that this coating acts as thermal insulation, which has the effect of increasing the temperature of the lip or lips.

An exemplary embodiment of the invention is described in greater detail below on the basis of a schematic diagram:

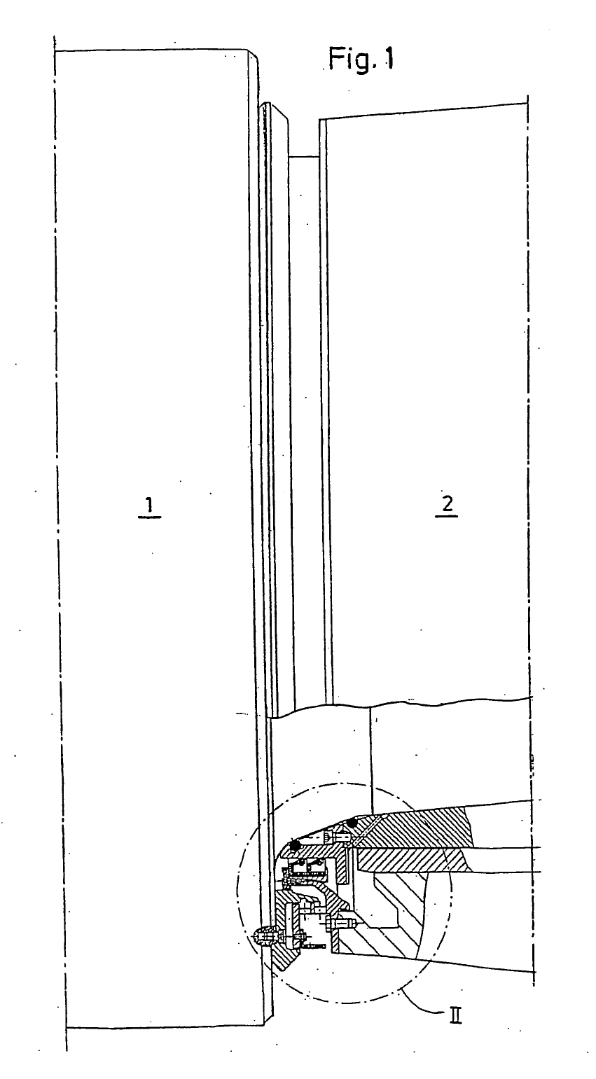

FIG. 1 shows part of a roll with an oil film bearing; and

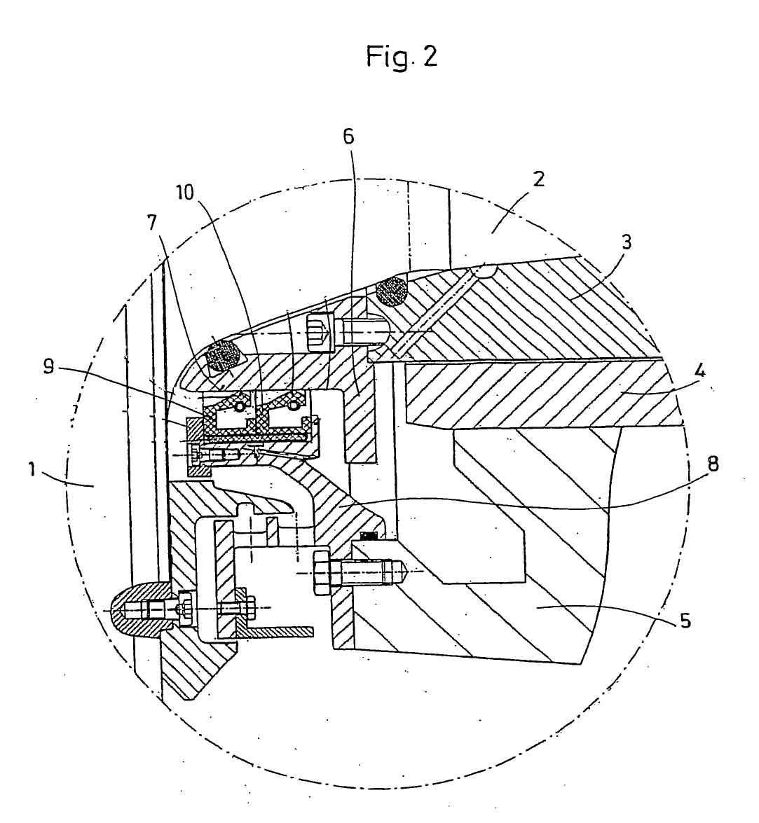

FIG. 2 shows a detailed view of the sealing area.

FIG. 1 shows a roll 1, which has a roll neck 2. A neck bush 3 is mounted on the roll neck 2. This bush in turn is mounted in a bearing bush 4. Between the neck bush 3 and the bearing bush 4, a lubricant such as oil is introduced to minimize friction. The bearing bush 4 is mounted in a chock 5, which is positioned in a stand window of the rolling stand (not shown).

So that the lubricant does not arrive on the roll 1 or on the roll neck 2, a sealing ring 6 is fastened to the neck bush 3, as shown in FIG. 2. This ring has a cylindrical sealing surface 7. Opposite the sealing surface 7 is a holder 8, which holds elastic sealing elements 9, 10. The holder keeps the sealing elements 9, 10 in position and prevents them from turning.

The sealing surface 7 in the sealing ring 6 is cylindrical, so that it will have constant contact with the elastic sealing elements 9, 10, i.e., with their the sealing lips 11, 12, even when the roll 1 and its roll neck 2 shift axially in the roll bearing.

1. Sealing device for roll bearings, especially oil film bearings or roller bearings, in which a sealing ring (6), which is connected to the roll neck (2) or to the neck bush (3), has a cylindrical sealing surface (7), against which an elastic sealing element (9, 10), mounted nonrotatably in a holder (8) connected to a chock (5), rests, wherein the sealing surface (7) is rolled.

2. Sealing device according to claim 1, wherein the sealing surface (7) is plasma-nitrided.

3. Sealing device according to claim 1, wherein the sealing surface (7) is oxidized.

4. Sealing device according to claim 1, wherein the elastic sealing element (9, 10) is a radial shaft seal ring.

5. Sealing device according to claim 4, wherein the radial shaft seal ring has support elements.
